(19) United States
(12) Patent Application Publication
(10) Pub. No.: US 2016/0271006 A1
(43) Pub. Date: Sep. 22, 2016

(54) Handheld manual massage device

(71) Applicant: Nicholas Jennings McGrue, Los Angeles, CA (US)

(72) Inventor: Nicholas Jennings McGrue, Los Angeles, CA (US)

(21) Appl. No.: 14/663,416

(22) Filed: Mar. 19, 2015

(51) Int. Cl. A61H 15/00

(52) U.S. Cl. CPC A61H 15/0092; A61H 2015/0042; A61H 2015/0014

(57) ABSTRACT

An embodiment of a handheld massage device (10) with a housing (11) for gripping connected to a sphere (13) by a rod (12) to roll along body parts to provide myofascial release, deep-tissue massage, acupressure massage, and other forms of relieving muscular tension.

### CROSS-REFERENCE TO RELATED APPLICATIONS

This application claims the benefit of provisional patent application Ser. No. 60/011,000 filed on Jun. 11, 2014 by the present inventor.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of massage devices. More particularly, the embodiment of the present Massage Device is in the technical field of manual, handheld massage devices.

Conventional massage devices that use a method of rolling the device and applying pressure, such as foam rollers or balls, are difficult to use due to their size or lack of ease in applying pinpointed pressure to muscles in need of myofascial release, deep-tissue massage, acupressure, or other forms of muscular tension relief. Use of some such devices, such as foam rollers, requires a large amount of space, generally requiring the user to lay down and roll or manipulate the user's entire body in order to receive the muscular tension release effects. The use of other devices, such as simple balls, are not well suited to allow users to apply optimal pressure to need areas, nor can they roll far enough while maintaining the desired pressure on affected muscles. Further, such devices have difficulty being used in a variety of locations, as they often require the user to sit down or lay down. Additionally, such devices find difficulty in providing myofascial release for larger muscles in confined areas. Finally, most of these devices rely on the use of large amounts of body weight in order to obtain the desired, results. The embodiment of the present Massage Device eliminates the need to use large amounts of body weight and/or large amounts of space, which allows the user to obtain the desired results in more environments and with more ease.

### BACKGROUND PRIOR ART

There are numerous devices on the market used for myofascial stimulation and release. However, many of them lack the portability, flexibility, and functionality of the present Massage Device.

Many devices consist of a larger instrument that the user must lay or sit down in order to receive the desired benefits—U.S. patent Ser. No. 05/968,496 (1980), Ser. No. 10/289,846 (2004), Ser. No. 09/011,144 (2000) and Ser. No. 12/800,159 (2010). These devices are generally larger and do not have the portability that the embodiment of the present Massage Device allows for. Additionally, the above devices generally target one or a few muscles on the body, similar to these inventions, Ser. No. 08/596,606 (1998) and Ser. No. 07/917,298 (1994). The present Massage Device can provide myofascial release to a majority of the user's muscles.

There are other devices that again, attempt to provide similar release but in different ways. Many devices such as U.S. patent Ser. No. 08/507,679 (1997), Ser. No. 08/791,916 (1998), and Ser. No. 08/434,865 (1997) do not have the rotational properties of the embodiment of the present Massage Device. The rotational property is an important aspect of the embodiment of the present Massage Device because it allows the user to apply pressure at specific spots but also allows for rolling along the affected muscle which provides further relief and release.

Other devices that do have rotational or rolling properties, lack ease of use when compared to the embodiment of the present Massage Device. Devices such as U.S. patent Ser. No. 05/547,445 (1976), and Ser. No. 08/368,147 (1994) allow the massage device to roll along the body. However, the user must insert the whole body or the whole affected limb into the device. This is not a convenient way to receive the desired release. The embodiment of the present Massage Device allows its use in many scenarios and environments such as the gym or even sitting at a desk in one's office.

Other devices such as U.S. patent Ser. No. 08/425,505 (1996), Ser. No. 08/671,966 (1998), and Ser. No. 10/339,052 (2005) possess the rotational characteristics of the embodiment of the present Massage Device. However, these devices are not manual and require a power source of some sort. The embodiment of the present Massage Device is completely powered by the user. There are no batteries or power that needs to connect to the device. The user is in sole control of the amount of pressure, or lack thereof used based upon the pressure that the user exerts on the embodiment of the present Massage Device toward the affected muscles.

While there are other devices that attempt to achieve, and sometimes successfully achieve, similar pursuits as the present invention, the embodiment of the present Massage Device provides a unique and superior alternative to achieving this desired muscular and myofascial release.

### BRIEF SUMMARY OF THE INVENTION

The present invention is a manual, handheld massage device having a housing that can be gripped in the hand, which is connected to a shaped rod that connects to a sphere. The connection between the shaped rod and sphere is in a manner that allows the sphere to rotate in relation to the housing and the user's body part. The invention allows the user to grip the housing applying manual pressure onto the effected areas of the body, and roll the sphere along the affected areas allowing for myofascial release in a plurality of areas on the body without the need for large amounts of space to receive the effects and/or benefits.

### BRIEF DESCRIPTION OF THE DRAWINGS

FIG. 1 is a perspective view of a preferred embodiment of the Massage Device constructed in accordance with the principles of the present invention;

FIG. 2 is an exploded view of FIG. 1;

FIG. 3 is a partially exploded view of FIG. 1;

FIG. 4 is a perspective view of the Massage Device demonstrating one of the numerous uses of the present invention; and

FIG. 5 is a perspective view of the Massage Device demonstrating a different one of the numerous uses of the present invention.

### DRAWING REFERENCE NUMERALS

| | | | |
|---|---|---|---|
| 10 | Massage Device | 11 | housing |
| 12 | shaped rod | 13 | sphere |
| 14 | hole in sphere | 15 | hole in sphere |
| 16 | shaped rod end | 17 | shaped rod end |

### DETAILED DESCRIPTION OF THE PREFERRED EMBODIMENTS

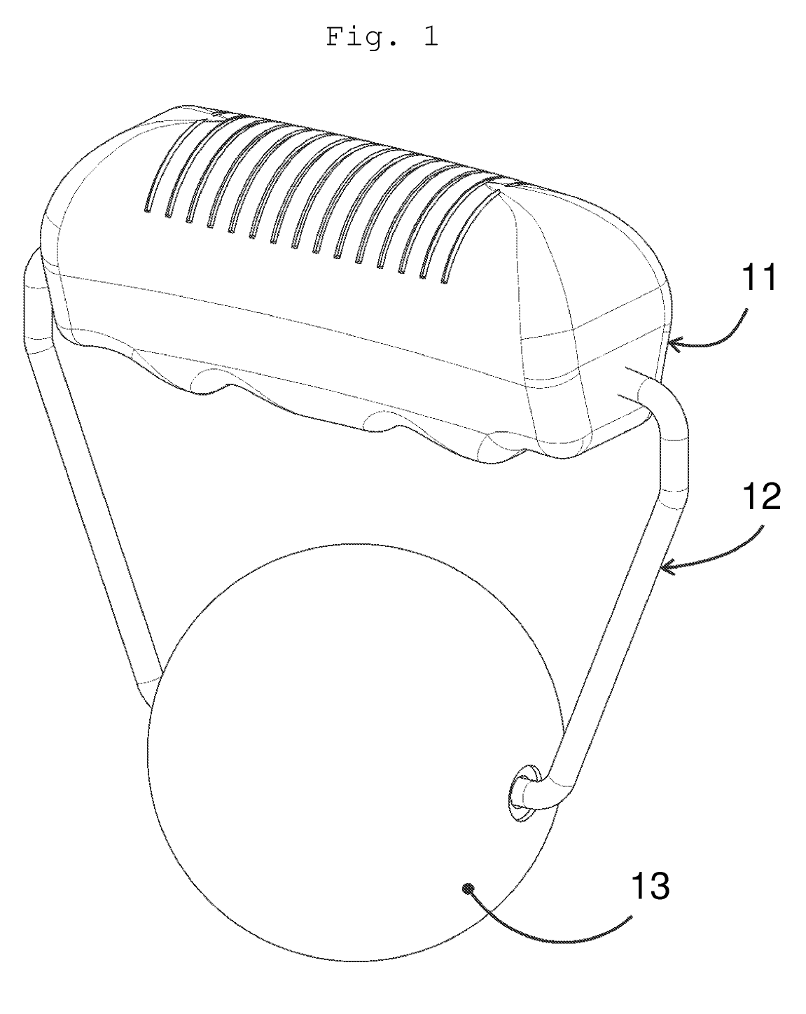

Referring now to the drawings of the embodiment of the present Massage Device in more detail in which like numerals indicate corresponding elements throughout the several views. Attention is first directed to FIG. 1 in which is seen a perspective view of a preferred embodiment of the present invention, a Massage Device. The Massage Device includes a housing 11, a shaped rod 12, and a sphere 13.

In more detail, still referring to the invention of FIG. 1, one preferred use of the Massage Device is for the user to grip the housing 11, while applying the desired amount of pressure to said housing 11, and then rolling the Massage Device in a manner such that the sphere 13 rolls along the user's effected bodily areas, allowing for myofascial release.

In further detail, still referring to the invention of FIG. 1, in a preferred embodiment, the sphere 13 has a circumference, size and diameter that are generally similar to a tennis ball or lacrosse ball. However, anyone of ordinary skill and knowledge in the field would know that larger or smaller spheres may also be used in the device. In a preferred embodiment, the dimensions of the housing 11 are dimensions that are generally sufficiently sized to be comfortable to a large audience when gripping the housing 11 in the user's hand. However, anyone of ordinary skill or knowledge in the field would recognize that different shaped housings, smaller housings, larger housings, extended housings, curved housings and the like may also be used in the device. In a preferred embodiment, the length of the shaped rod 12 is generally a length that allows for the shaped rod 12 to connect with the sphere 13 and housing 11 as described above and further described below.

The construction details of the invention as shown in FIG. 1 may generally consist of housing 11 that is preferably made of moderately pliable material such as plastic or rubber that is rigid enough to hold its shape when gripped, but flexible enough for comfortable gripping in the hand. In a preferred embodiment, the construction of the shaped rod 12 is preferably made of rigid material such as a hard rubber or metal. In a preferred embodiment, the construction of the sphere 13 is preferably made of a semi-rigid material that allows for some flexibility such as plastic or rubber. It understood that someone of ordinary skill or knowledge in the field may use different materials other than those described above for the Massage Device.

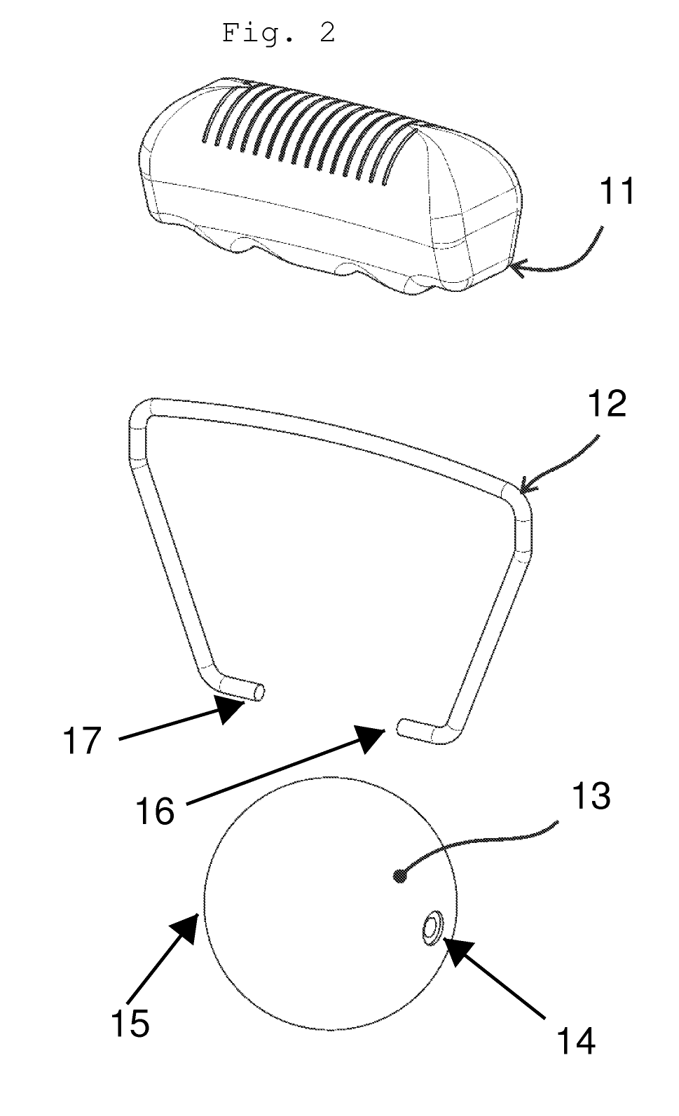

As further seen in FIG. 2, an exploded view of the invention seen in FIG. 1, the Massage Device's shaped rod 12 has two ends 16 and 17 that connect to the sphere 13 on opposite ends in the center of the sphere 13 through holes 14 and 15 which allow for the sphere 13 to rotate. In a preferred embodiment, holes 14 and 15 do not go completely through the sphere 13. Instead, holes 14 and 15 are drilled just deep enough to provide a sturdy and solid connection to the shaped rod 12 through its ends 16 and 17. However, someone of ordinary skill or knowledge in the field may also drill completely through the sphere 13 such that holes 14 and 15 essentially become one hole with entrances/exits.

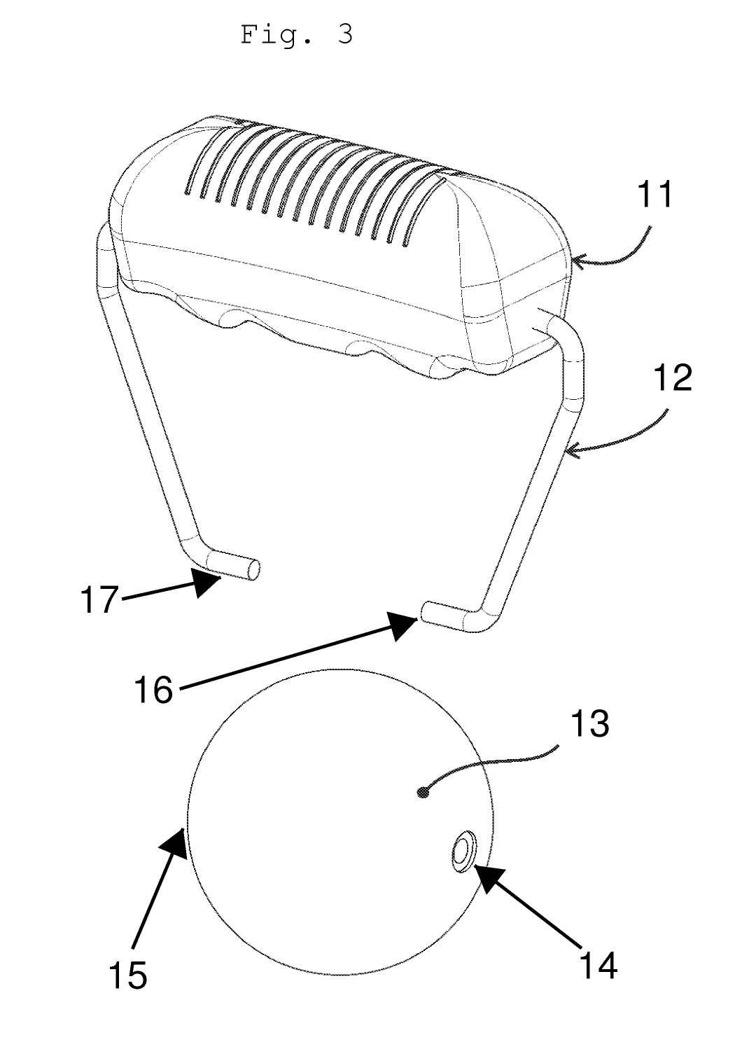

As further seen in FIG. 3, a partially exploded view of the invention seen in FIG. 1, the Massage Device's shaped rod 12 connects to the housing 11 by intersecting it.

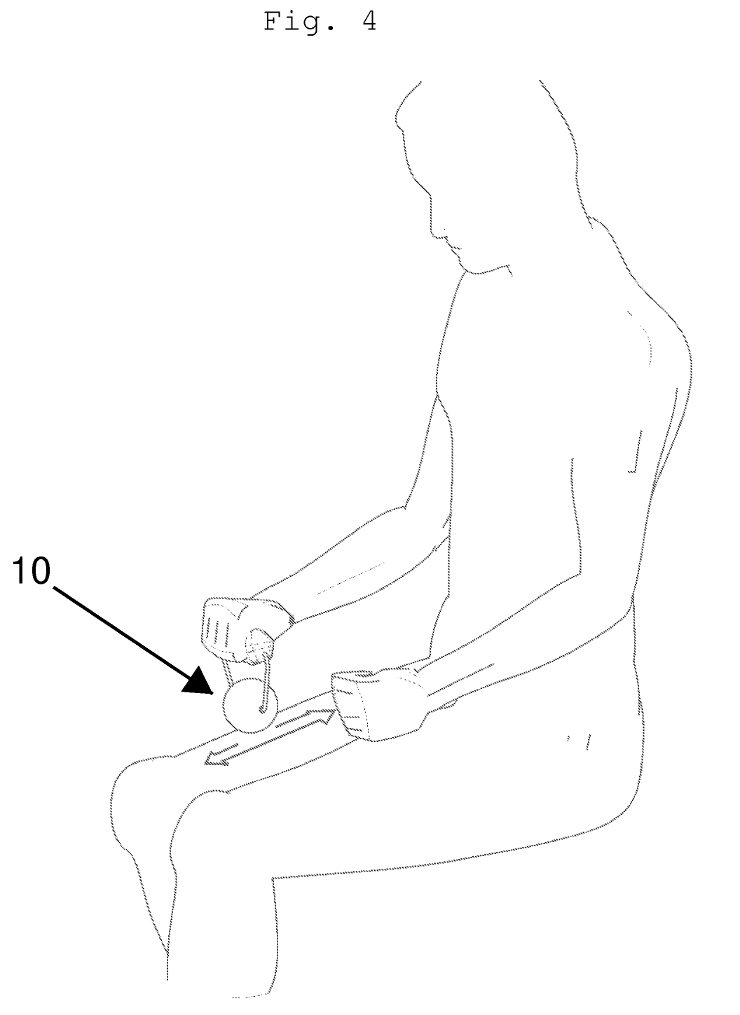

Referring now to FIG. 4, Massage Device 10, is seen rolling along a leg muscle to provide myofascial release. FIG. 4 is one demonstration of a myriad of ways in which the present invention may be used and should not be viewed as a limitation of uses. In FIG. 4, Massage Device 10 is shown while the user grasps the Massage Device 10 and applies manual pressure to the effected area, moving the Massage Device 10 in a “back and forth motion.” Through this use and movement, the user is able to provide itself with myofascial release and loosening of tight muscles.

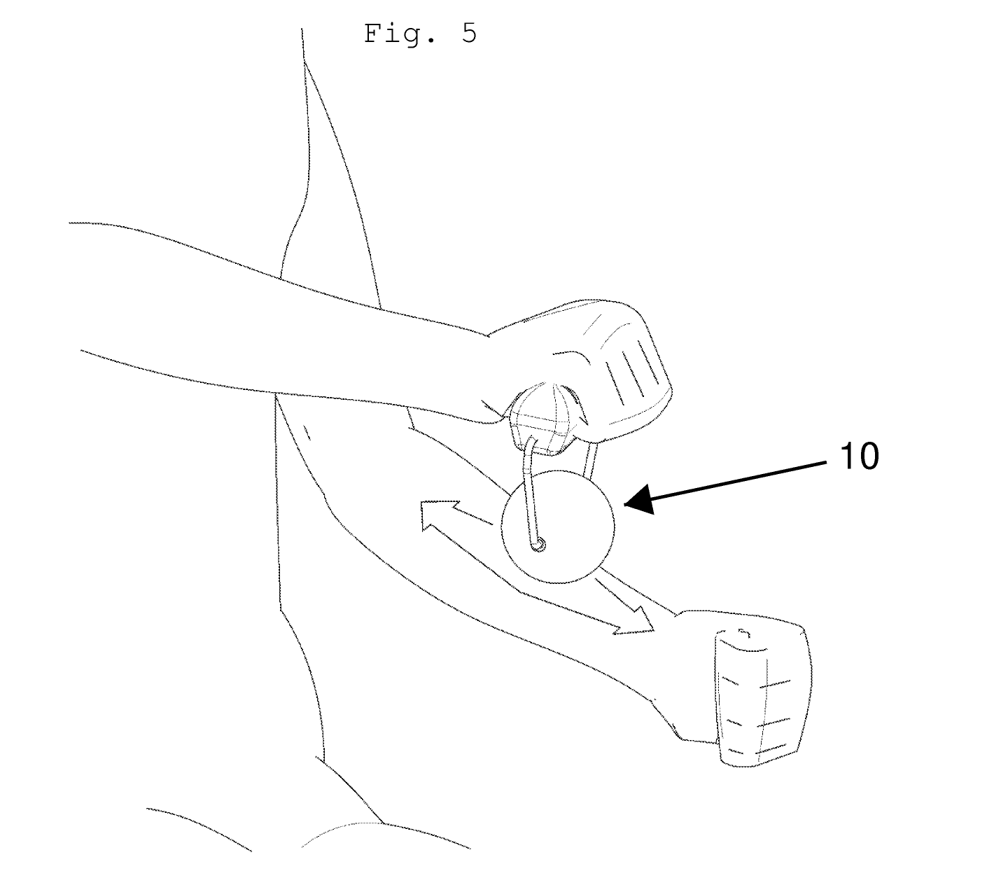

As further seen in FIG. 5, Massage Device 10, is again seen rolling along a muscle to provide myofascial release. FIG. 5 is just another demonstration of a myriad of ways in which the present invention may be used and should not be viewed as a limitation of uses. The Massage Device 10 may be used on most muscles of the body to ease aches, pains, tension, soreness, and provide myofascial release.

The advantages of the embodiment of the present Massage Device include, without limitation, a small size, the ability to apply as much or little manual pressure as desired, portability, easy to use in multiple environments, application on numerous body parts, use in confined areas, and ergonomic design for comfort during use.

In other embodiments the device may use a plurality of spheres, a rotating object of a shape different than a sphere such as a cylinder, a plurality of rotating objects of a shape different than a sphere, a textured sphere, a plurality of textured spheres, a textured rotating object of a shape different than a sphere, a plurality of textured rotating objects of a shape different than a sphere, an elongated housing, a plurality of housings, a plurality of elongated housings, a plurality of rods, and size variations of all the components. Other embodiments may also consist of a combination of the above and the addition of the use of bearings or lubricants to ease with rotation. Other embodiments may create the elements of the Massage Device using materials different than those described herein. The device is also not limited to myofascial release but may also be used for deep-tissue therapy, acupressure, active release therapy, and other forms of relieving bodily ailments.

In broad embodiment, the present invention is a manual, handheld massage device that is graspable in the hand with a rod connecting the graspable element to at least one rotating element that rolls along body parts.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

I claim:

1. A massage device, comprising of:
A housing as a means for gripping;
Connected to a rod;
With said rod connected to a sphere in a manner that allows said sphere to rotate and/or roll along the body.

2. The invention of claim 1 further comprised of a plurality of rotating spheres.

3. The invention of claim 1 further comprised of a bearing affixed to the rod where said rod connects with the sphere.

4. The invention of claim 1 further comprised of a textured sphere.

5. The invention of claim 1 further comprised of a plurality of rods.

6. A massage device, comprising of:
A housing as a means for gripping;
Connected to a rod;
With said rod connected to a cylinder in a manner that allows said cylinder to rotate and/or roll along the body.

7. The invention of claim 6 further comprised of a plurality of rotating cylinders.

8. The invention of claim 6 further comprised of a bearing affixed to the rod where said rod connects with the cylinder.

9. The invention of claim 6 further comprised of a textured cylinder.

10. The invention of claim 6 further comprised of a plurality of cylinders.

11. The invention of claim 1 further comprised of a plurality of housings.

12. The invention of claim 6 further comprised of a plurality of housings.

13. The invention of claim 1 further comprised of a lubricant as a conduit between said rod and said sphere.

14. The invention of claim 6 further comprised of a lubricant as a conduit between said rod and said cylinder.
